(19) United States
(12) Patent Application Publication
(10) Pub. No.: US 2003/0035092 A1
(43) Pub. Date: Feb. 20, 2003

(54) Light pattern projection system

(76) Inventors: Brian Bramlett, Portland, OR (US); James Okuley, Portland, OR (US)

Correspondence Address: MARGER JOHNSON & McCOLLOM, P.C., 1030 SW Morrison Street, Portland, OR, 97205, US

(21) Appl. No.: 09/931,185

(22) Filed: Aug. 15, 2001

(51) Int. Cl. G03B 27/72

(52) U.S. Cl. 355/69; 355/67; 355/68; 355/71; 250/492.2; 250/492.22; 355/53

(57) ABSTRACT

A light projection apparatus comprising a plurality of light emitting diodes (LEDs) of two or three primary colors adapted to provide light along a light path common to said LEDs. The output color of the collective diodes is controlled by displaying the various colors at carefully controlled intensities, and the resulting colored light projected through a transmissive LCD matrix interposed within the light path resulting in a light pattern. A mirror positioned within but at an oblique angle to the light path reflects the light pattern in a direction dictated by the angle of the mirror to the light path where the angle axis is modified by a pair of worm drives affixed to transverse axes of the mirror mount.

### BACKGROUND OF THE INVENTION

This invention relates generally to an image projection apparatus and, more particularly, to an apparatus for projecting and moving an image on a surface without moving the image creation portion of the apparatus.

Rudimentary light pattern projection systems have existed for many years. These systems include a colored gel fitted over the housing of a light bulb mounted on overhead scaffolding. The gel typically comprises a two-ply sheet of plastic—a black layer having a pattern cut out of it and another colored layer covering the patterned opening in the black plastic. Light would be blocked by the black plastic but would be filtered by the colored plastic layer to project a colored light pattern onto a remote surface. Mechanicals within the scaffolding would steer the lights in a desired direction. Many nightclubs have used this method for projecting moving light patterns onto surfaces to enhance the music.

There are several disadvantages to the above system. First, the color of the light is limited to the color of the gel used. Second, the pattern projected is fixed by the pattern formed in the gel. And finally, the mechanicals used to steering the light generation and filtration portion of the system are bulky and expensive.

Later developments in the art have introduced a plurality of gels of varying colors and with varying patterns that can be rotated into position in front of the light. While introducing more flexibility into the light projection system, these systems require bulky mechanicals, are limited in the speed at which colors and patterns can change, and do not allow pattern and color to by independently controlled.

The present patterned light projection apparatus is intended to address these deficiencies in the art.

### BRIEF DESCRIPTION OF THE DRAWINGS

The objects, features and advantages of the invention will become more readily apparent from the following detailed description of a preferred embodiment of the invention that proceeds with reference to the accompanying drawings.

FIG. 1 is an exploded isometric view of a light projection apparatus constructed according to a first embodiment of the invention.

FIG. 2 is a schematic illustration of the apparatus of FIG. 1.

FIG. 3 is a face on plan view of the LED lighting assembly used in a preferred embodiment of the invention comprising an array of LEDs of various primary colors.

FIGS. 4A through 4D illustrate representative graphs of the light intensity used to drive the primary color LEDs within the light projection apparatus to form various colors.

FIG. 5 is a perspective view of a preferred embodiment of the steering means used to direct light in a desired one of a plurality of directions.

### DETAILED DESCRIPTION

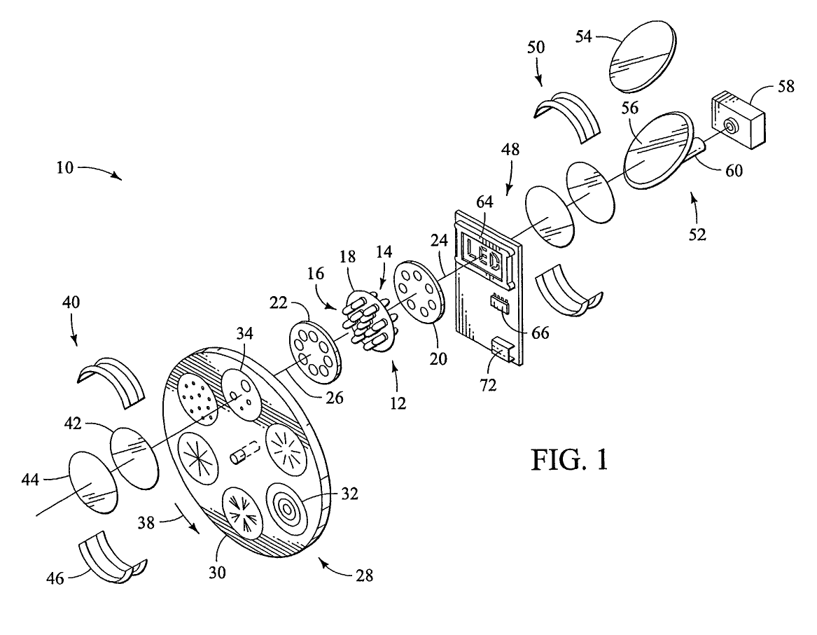

The light projection system constructed according to a preferred embodiment of the invention is shown generally in the exploded view at 10 in FIG. 1. The light projection system 10 includes a light source, here shown by an LED array 12 comprising a plurality of light emitting diodes mounted on either side 14, 16 of a substrate 18. An array of microlenses 20, 22 are positioned in front of each LED array side 14, 16 to project illumination and collimate the light from the respective LED array along a light path 24, 26.

A first patterning means 28 is interposed within light path 26. Patterning means 28 includes a wheel 30 having a plurality of pattern windows, such as windows 32 and 34, formed along a periphery of the wheel. Each pattern window includes portions through which light can pass and other portions through which light is at least partially blocked and does not (but could) include a color gel inserted therein. Window 34, for instance, includes pattern means for forming four circles while window 32 includes pattern means for forming a bull's-eye design. Wheel 30 also includes a wheel axis 36 on which the wheel is mounted for rotational movement along arrow 38 around axis 36 to thereby present one of the plurality of windows, such as window 34, within the light path. A stepper motor (not shown) coupled to the wheel axis 36 can be manually activated to rotate the wheel to present the various windows 32, 34 or can be rotated under the control of a computer, responsive to the detected beats of music or other known means. Light generated within the LED array on side 16 is projected through the microlens array 22 and pattern window 34 to yield a patterned image. Alternate patterning means 28 that can be interposed within the light path 26 include patterned dichroic glass, prisms, and oil wheels.

Pattern focusing optics 40, here formed by two lenses 42, 44 fixed within a bracket assembly 46, is interposed within light path 26 after the first patterning means 28 to focus the pattern formed thereby onto a remote viewing surface (not shown).

Interposed within light path 24, originating from the first LED array side 14, is a second, dynamic patterning means 48, a second set of pattern focusing optics 50, and steering means 52 for directing light in a desired one of a plurality of directions. Dynamic in this context refers generally to a mechanically stationary transmissive element having a plurality of subdisplay elements (e.g. pixels) under computer control to present changeable patterns within the transmissive element. As will be described further below with reference to FIG. 5, the steering means constructed according to a preferred embodiment of the invention includes a mirror 54 mounted to a moveable surface 56 that is rotatable by motor means 58 about an axis 60.

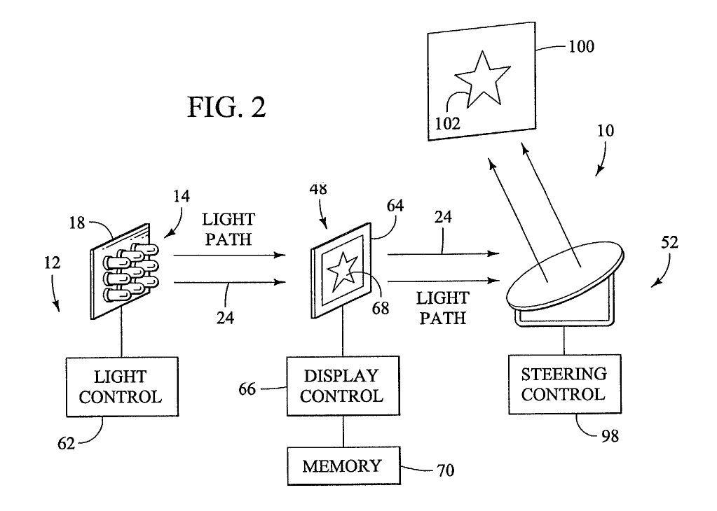

FIG. 2 illustrates a schematic view of the light projection apparatus 10 formed by light source 12 for projecting light along light path 24, dynamic patterning means 48 and steering means 52.

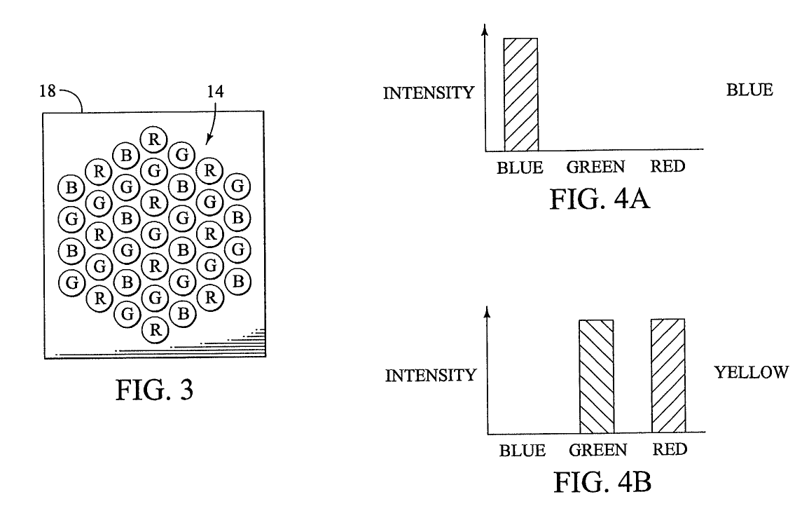

The light source 12 preferably includes a plurality of light emitting diodes (LEDs) of at least a first color and a second color adapted to provide light along the light path 24 common to the LEDs. The light source can optionally include a third color also adapted to provide light along a light path 24 common to the other LEDs. An arrangement of the three color LEDs is shown in FIG. 3, where the LED array 14 includes first, second and third primary colors red R, green G, and blue B. The individual LEDs are arranged within the array so that they are adjacent to LEDs of different primary colors to effect good mixing of the light colors for color control as described below.

The light source includes a light controller 62 with intensity control means for controlling the intensity of the LEDs colors independently of one another. Examples of such light intensity control means, such as those described in U.S. Pat. Nos. 6,016,038 (Mueller) and 5,184,114 (Brown), are known in the art and thus not described further here.

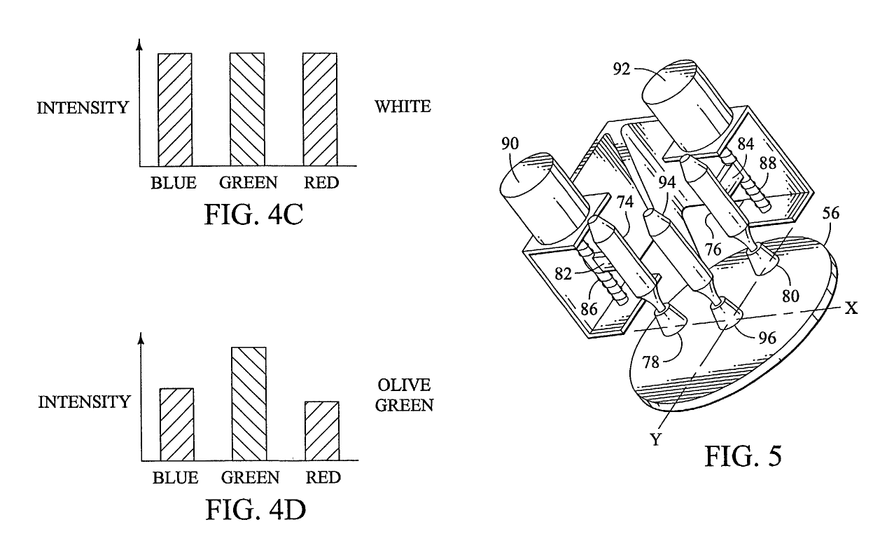

FIGS. 4A through 4D illustrate how the light controller 62 can be used to generate a variety of different colors from the differently colored LEDs. It is understood that a light source 12 having LEDs of even just two different color can be used to generate many different colors. The graphs in FIGS. 4A through 4D illustrate how blue, yellow, white and olive green, respectively, can be generated by altering the intensity of each of the three primary colors LEDs. In FIG. 4A, blue is a primary color so only the blue B LEDs are lit to generate the blue light. In FIG. 4B, yellow is a combination between green and red light and thus green and red color LEDs are lit while the blue LEDs are turned off. For white light, FIG. 4C shows that all three primary colors should be lit to equal intensity. And finally, FIG. 4D shows that olive green results from the intensity of each of the three colors being carefully controlled relative to one another.

Returning to FIG. 2, the preferred patterning means shown is a transmissive-type LCD matrix display 64 having a plurality of pixels. The dynamic patterning means 48 further includes a display controller 66 for actuating the pixels to form a pattern, such as the star shape 68 shown on the LCD display 64. A memory 70 coupled to the display controller 66 stores a plurality of different patterns therein. Each pixel of the display 64 is generally controlled by one bit and is therefore on or off. To form a star pattern, therefore, the pixels outside of the star must be controlled so that they are non-transmissive (black) while the pixels within the star must be controlled so that light passes through that portion of the display. The (black) pattern formed on the LCD matrix display 64 is thus inversely related to the light pattern ultimately projected onto a surface. For multibit displays (e.g. grayscale displays), the display controller includes means for addressing each pixel of the transmissive LCD matrix with two or more bits of data so that each pixel is capable of passing a partial amount of light from the light source 12.

The dynamic patterning means 48 is therefore capable of interposing within the light path 24 a plurality of patterns 68 limited only by the number of patterns stored in memory 70. This is in contrast to the first patterning means 28 where the number of patterns is limited to those defined along the periphery of the gobo (short for “go between”) wheel 30. Additionally, the LCD display 64 is capable of changing patterns more quickly than a gobo such as wheel 30, the display controller can be arranged to create moving/evolving patterns (formerly impossible with the gobo), and is also more reliable since it has few if any moving mechanical parts. It is understood that the present invention is not limited to LCD technology since any transmissive, pixel-related technology can be used to serve the same purpose. It is also understood that the display controller can be bypassed and control passed to an external laptop or similar computer device coupled to the patterning means 48 as through Universal Serial Bus (USB) port 72 (FIG. 1).

FIG. 5 shows a perspective view of a preferred embodiment of the steering means 52 used to direct light in a desired one of a plurality of directions. The steering means 52 includes a gimbaled mirror mount 56 with mirrored surface 54 (FIG. 1). A pair of posts 74, 76 are coupled via ball joints 78, 80 to respective transverse axes X, Y of the mirror mount. The posts 74, 76 include respective slider screws 82, 84 that engage with the threads of respective worm gears 86, 88 driven by respective motors 90, 92. A third post 94 is coupled to the intersection of the X- and Y-axes along the mirror axis through ball joint 96.

As the motors turn the worm gears, the engaged slider screw moves up or down the gear depending upon the thread direction and direction of gear rotation. Turning the gear 86 in a clockwise direction, for instance, acts to move slider screw 82, post 74 and ball joint 78 upward, thus tilting the mirror mount about the Y axis. Turning the gear 88 in a counter-clockwise direction acts to move slider screw 84, post 76 and ball joint 80 downward, thus tilting the mirror mount about the X axis.

Turning back to FIG. 2, the mirror axis is at an oblique angle to the light path 24 so that the light path is directed at twice the oblique angle toward a projection surface 100 on which the resulting image 102 is displayed. The motors 90, 92 are under the control of the steering controller 98 (FIG. 2) to change this oblique angle and tilt the mirror in the desired direction so that the light from the light source 12 and patterning means 48 is directed in a desired one of a plurality of directions. Alternately, the third post is coupled to motor means 58 to rotate the tilted mirror about the mirror central axis to move the patterned image across an arc of projection surface 100.

The invention further comprises a method for projecting a light pattern onto a projection surface. The method comprises directing light along a light path, such as light generated from LED array 14 along light path 24. A selected one of a plurality of patterns is displayed on a display device, such as a grayscale image, interposed within the light path to form a light pattern. The light pattern is then reflected off of a mirror in a first direction. The mirror is then moved such that the light pattern is reflected off of the mirror in a second direction different from the first.

As evident from the apparatus described above, the method further includes providing a plurality of LEDs capable of generating light along the light path of a first primary color (e.g. red), a second primary color (e.g. green) and a third primary color (e.g. blue). The method further includes the step of regulating the intensity of light output from the LEDs for each of the first, second and third primary colors to yield colored light.

The direction in which the light pattern is reflected is regulated by tilting the mirror in a first mirror axis and tilting the mirror in a second mirror axis transverse to the first. The mirror can further be rotated around a third transverse axis to further control the direction of light pattern reflectance.

Having described and illustrated the principles of the invention in a preferred embodiment thereof, it should be apparent that the invention can be modified in arrangement and detail without departing from such principles. Accordingly, we claim all modifications and variation coming within the spirit and scope of the following claims.

What is claimed is:

1. A light projection apparatus comprising:
a light source adapted to project illumination along a light path;
dynamic patterning means interposed within the light path for forming a light pattern; and
steering means within the light path for directing the light pattern in a desired one of a plurality of controllable directions.

2. The apparatus of claim 1, wherein the light source includes a plurality of LEDs of at least a first color and a second color adapted to provide light along the light path common to said LEDs.

3. The apparatus of claim 2, wherein the plurality of LEDs includes a third color adapted to provide light along a light path common to said LEDs.

4. The apparatus of claim 3, wherein the first color LED, second color LED and third color LED are respectively a first primary color LED, a second primary color LED, and a third primary color LED.

5. The apparatus of claim 2, further including intensity control means for controlling the intensity of the first color and the second color of the plurality of LEDs independently of one another.

6. The apparatus of claim 1, wherein the dynamic patterning means includes:
a transmissive LCD matrix interposed within the light path, said matrix comprised of a plurality of pixels; and
means for selectively actuating the pixels to form a pattern, said pattern preventing light received from said LEDs from continuing along said light path and through said pixels forming said pattern to thereby form a light pattern inversely related to said pattern.

7. The apparatus of 6, farther including memory means having a plurality of different patterns stored therein.

8. The apparatus of claim 6, wherein said means for selectively actuating the pixels includes means for addressing each pixel of the transmissive LCD matrix with two or more bits of data so that each pixel is capable of passing a partial amount of light from the light source.

9. The apparatus of claim 8, wherein the transmissive LCD is a grayscale LCD.

10. The apparatus of claim 2 wherein the patterning means includes:
a wheel having a plurality of pattern windows formed along a periphery of the wheel; and
a wheel axis on which the wheel is mounted for rotational movement around the axis to thereby present one of the plurality of pattern windows within the light path.

11. The apparatus of claim 1, wherein the steering means includes a mirror having a central axis at an oblique angle to the light path.

12. The apparatus of claim 11, further including means for tilting the mirror in a first axis transverse to the mirror axis.

13. The apparatus of claim 12, further including means for tilting the mirror in a second axis transverse to the mirror axis and the first axis.

14. A light projection apparatus comprising:
a plurality of LEDs of at least a first color and a second color adapted to provide light along a light path common to said LEDs;
intensity control means for controlling the intensity of the first color and the second color of the plurality of LEDs independently of one another;
a transmissive LCD matrix interposed within the light path, said matrix comprised of a plurality of pixels;
means for selectively actuating the pixels to form a pattern, said pattern preventing light received from said LEDs from continuing along said light path and through said pixels forming said pattern to thereby form a light pattern inversely related to said pattern;
a mirror interposed within the light path to intercept said light pattern and having a mirror axis at an oblique angle to said light path; and
steering means for changing the oblique angle of the mirror axis relative to said light path.

15. The apparatus of claim 14, wherein the plurality of LEDs includes a third color adapted to provide light along a light path common to said LEDs.

16. The apparatus of claim 15, wherein the first color LED, second color LED and third color LED are respectively a first primary color LED, a second primary color LED, and a third primary color LED.

17. The apparatus of claim 14, wherein said means for selectively actuating the pixels includes memory means having a plurality of different patterns stored therein.

18. A method for projecting light onto a projection surface comprising:
directing light along a light path;
displaying a selected one of a plurality of patterns on a display device interposed within the light path to form a light pattern;
reflecting the light pattern off of a mirror in a first direction;
moving the mirror; and
reflecting the light pattern off of the mirror in a second direction.

19. The method of claim 18, further including:
providing a plurality of LEDs capable of generating light along the light path of a first primary color, a second primary color, and a third primary color; and
independently regulating the intensity of light output from the LEDs for each of the first, second, and third primary colors to yield colored light.

20. The method of claim 18, wherein the step of moving the mirror includes:
tilting the mirror in a first mirror axis; and
tilting the mirror in a second mirror axis transverse to the first mirror axis.

21. The method of claim 20, wherein the step of moving the mirror further includes rotating the mirror around a third mirror axis transverse to the first and second mirror axes.

22. The method of claim 18, wherein the step of displaying a selected one of a plurality of patterns includes displaying a grayscale image on the display device.
